(19) United States
(12) Patent Application Publication
(10) Pub. No.: US 2024/0225319 A1
(43) Pub. Date: Jul. 11, 2024

(54) DRAINAGE ELEMENT FOR PLANTS, AND USE THEREOF

(71) Applicant: Mario BROWA, Geroldsgruen (DE)

(72) Inventor: Mario BROWA, Geroldsgruen (DE)

(21) Appl. No.: 18/615,685

(22) Filed: Mar. 25, 2024

Related U.S. Application Data
(63) Continuation of application No. 17/108,993, filed on Dec. 1, 2020, now abandoned.
Application No. 17/108,993 is a continuation of application No. 16/075,925, filed on Aug. 6, 2018, now abandoned.

(30) Foreign Application Priority Data
Feb. 22, 2016 (DE) 10 2016 103 065.1

(51) Int. Cl. A47G 7/04; A01G 9/033; A01G 13/02; B32B 5/02; B32B 5/26; E04D 11/00

(52) U.S. Cl. CPC A47G 7/041; A01G 9/033; A01G 13/0256; A01G 13/0268; A01G 13/0281; B32B 5/024; B32B 5/26; E04D 11/002; B32B 2410/00; Y02A 30/254; Y02B 80/32

(57) ABSTRACT

The invention relates to a planar textile drainage element for preventing moisture to accumulate around plants, as well as to the use thereof.

### CROSS REFERENCE TO RELATED APPLICATIONS

This application is a continuation of U.S. patent application Ser. No. 17/108,993, filed Dec. 1, 2020, which in turn is a continuation of U.S. patent application Ser. No. 16/075,925, filed Aug. 6, 2018, which in turn is a US National Phase entry of PCT International Patent Application Serial No. PCT/EP2017/053789, filed Feb. 20, 2017, the contents of which are incorporated herein by reference.

### BACKGROUND OF THE INVENTION

The invention relates to a textile drainage element of areal form for avoidance of waterlogging at plants and to the use thereof.

In the cultivation of plants in nurseries or also presentation thereof in specialised markets, large-area watering is carried out by sprinkling over or by flooding support surfaces. The excess water which after watering is frequently centimetres-high is after a certain period of time drained away or for the most part flows away by itself. However, watering procedures of that kind cause puddles, particularly in the case of uneven ground, and undesired waterlogging between plant container and ground. Due to capillary and cohesion forces the water employed in watering cannot completely drain away between plant container and ground so that residual water always remains below the plant container. This waterlogging can lead to microbial growth and root rot, as a result of which the plants are damaged and no longer saleable. The residual water below the plant container frequently cannot dry out by itself due to the absence of air supply.

In addition, in the case of cultivation of plants in plant containers such as, for example, flower pots of clay, ceramic or plastic there is the fundamental problem of waterlogging in the case of excessive watering. This has the consequence, as already described above, of root rot and pest infestation or pest multiplication. In addition, the plant is thereby subject to lasting damage and often completely dies.

The same problem of waterlogging also arises in the case of roof greenery, in which in the case of wet weather it always has to be ensured that the incident rainwater is completely drained away so as to preclude root rot and ultimately also to protect greenery and vegetation. In addition, it is also always necessary to take into account here the requirements of the load-bearing capability of the roof concerned.

Solutions are known from the prior art which use, for example, clay balls as plant substrate or gravel as drainage material so as to drain excessive water from watering away from the roots. However, these materials have proved disadvantageous in the cultivation of plants, since they are costly. Thus, for example, the entire bedding area in a nursery would have to be furnished with appropriate clay balls. This imposes an enormous cost burden. In the case of roof greenery use is made of gravel and non-woven materials as drainage. Due to its high weight, gravel, in particular, has proved disadvantageous for relevant roof constructions. The load-bearing capability is thereby significantly taxed.

Consequently, the present invention has the object of making available a drainage element which has a low intrinsic weight and which is constructed to be easily usable and layable.

### SUMMARY OF THE INVENTION

A significant point of the invention resides in the fact that the textile drainage element of areal form for avoidance of waterlogging at plants comprises at least one first textile layer for accepting at least one plant container or plant substrate and at least one second textile layer for improved drainage of a liquid, wherein the second textile layer is arranged to be opposite the first textile layer in terms of area and at least one areal spacer element is arranged between first textile layer and second textile layer and fixedly connects the two layers together. With particular advantage, the plant drainage element described herein is a plant drainage element.

Advantageously, the drainage element for plants described herein is constructed from textile fibres, advantageously as a fabric. In that case it is conceivable for the first and second textile layers to be formed from the same fibre material. Moreover, it is also conceivable for these two textile layers to be composed of different fibre materials. Advantageously, the two textile layers are each constructed as a fabric, these being fixedly connected together by way of an areal spacer element. Advantageously, the areal spacer element is constructed in such a way that formed between the first textile layer and the second textile layer are cavities by way of which water from watering can be drained away from the plant container or plant substrate.

Consequently, the spacer element spaces the two textile layers from one another.

With particular advantage the drainage element is constructed as a textile mat which can be cut up so that it is simply and quickly adaptable in its size to the respective use and can be arranged not only in a plant container, but also under a number of plant containers.

The textile construction of the drainage element is of particularly advantage since the desired stability of shape, but at the same time also resilience, of the drainage element are thereby produced. The drainage element described herein is constructed to be flexible and in the case of application of force, particularly application of pressure, advantageously substantially retains its desired shape without giving rise to undesired deformation of the layers and/or the spacer element. The best-possible drainage function of the drainage element due to the large-volume cavities between the two layers, which are spanned by the spacer element, is present in the desired shape.

Further advantageous embodiments are evident from the subclaims.

In a further advantageous form of embodiment the spacer element is constructed as at least one spacer thread. It has proved advantageous to construct the spacer element as a spacer thread, since this imparts resilience and deformability to the drainage element. In that regard, by “spacer thread” there is to be understood at least one textile thread which fixedly connects the first textile layer with the second textile layer. In that case it has proved particularly advantageous to construct the spacer thread as a monofilament or as a polyfilament. The monofilament is advantageously of endless and single-thread construction and can thus be incorporated between the two textile layers in simple manner without substantial production cost. Costs can thus be saved.

In a further advantageous form of embodiment it has proved advantageous if the at least one spacer thread, advantageously constructed as a monofilament, has an oblique shape and/or a curved shape in its course between first textile layer and second textile layer. As a result, displaceability and/or movability of the first and second textile layers relative to one another is achieved without the drainage element as a whole being damaged in the event of external application of force. Consequently, the oblique and/or curved path of the spacer thread is advantageous for additional flexibility and resilience of the drainage element, since an additional displacement path is thereby provided. One possible course of the spacer thread is, for example, a zig-zag path. It is also conceivable to provide, for example, two spacer threads which cross one another and are formed to be fixed together at the crossing point.

If, for example, a plant container is placed on the textile drainage element it is possible for the first textile layer to either remain in its desired shape or, however, to be deflected from its desired shape and deformed due to the weight of the plant container and the resultant vertically downwardly directed application of force. The at least one spacer thread, advantageously the monofilament, makes possible corresponding deflection from the desired shape particularly to the extent that first textile layer and second textile layer are formed to be free of contact with one another. The at least one spacer thread thus always holds the first textile layer and second textile layer separately from one another so that, even in the case of a heavy plant container, contact of the two layers with one another is prevented.

If now the corresponding plant container is removed from the textile drainage element, for example lifted off, then the at least one endless spacer thread causes return of the deflected textile drainage element to its original desired shape. With advantage, the at least one endless spacer thread, advantageously a monofilament, is thus constructed as a spring element which enables reversible shape change of the drainage element in the case of application of force and always returns this to its desired shape at the conclusion of the application of force.

Through the advantageous construction of the spacer element as at least one endless spacer thread, a plurality of spacer thread sections having, for example, a spring function is formed between first and second textile layers.

It has proved advantageous if the drainage element in its desired shape, thus in its unchanged initial shape without application of force, has a material thickness of in total 1 to 400 millimetres. A material thickness in the range of 2 to 50 millimetres has proved to be of particular advantage and 9 millimetres even more advantageous. Depending on the respective form of embodiment it is additionally conceivable for the first textile layer to be spaced from the second textile layer in the desired shape in the range of 2.5 to 300 millimetres, more advantageously 10 to 40 millimetres.

The at least one monofilament advantageously has a diameter of 0.05 millimetres to 3 millimetres. The measurements stated herein have proved advantageous, since the best possible drainage effect between plant container and ground can thereby be achieved.

In that regard, the inclined and/or curved form of the incorporated spacer thread has proved of advantage in order to return the drainage element quickly and reversibly to its desired shape after ending of an external pressure loading, for example when a plant container is lifted up. In particular, in that regard a crescent-shaped course has proved particularly advantageous in order to quickly return the two layers back to the desired shape of the drainage element after application of force has ended, since the curved spacer thread sections have a sufficient restoring force. Obviously, provided between the two layers is not only a single curve course of that kind, but a plurality—advantageously 50 to 500—of spacer thread sections of crescent-shaped form per square centimetre, these being formed from a single monofilament.

For that purpose, the monofilament is advantageously formed to be looped together with the first textile layer and the second textile layer. Looping of that kind is advantageous since a fixed connection of the monofilament with the two textile layers is thereby formed and at the same time and depending on the extent of looping a plurality of spacer thread sections, which are advantageously formed to be curved, arises between the two textile layers. This is clearly of advantage not only from the production aspect, but also from the cost aspect.

The number of curved spacer threads between the two textile layers depends on the respective degree of looping. If, for example a large degree of looping is selected then a large number of curved spacer thread sections also results, whereagainst a smaller degree of looping produces a correspondingly small number of curved spacer threads. Consequently, the degree of looping in addition to the spacer thread shape advantageously serves the purpose of influencing, in particular, the load-bearing capability and pressure stability of the textile drainage element.

In this connection, in a further advantageous form of embodiment it has proved to be desirable if the spacer thread sections, which are constructed from a monofilament, define together with the second textile layer an angle of inclination in the range of 1° to 130°.

The second textile layer is advantageously the lower layer resting directly on the soil or, for example, the plant table or roof surface or another substrate. The angle of inclination of the spacer thread sections is oriented to, in particular, the path of the spacer thread sections. In the case of a path, which is formed to be curved, of the respective spacer thread sections it has proved advantageous to form the angle of inclination between spacer thread section and second textile layer in the range of 1° to 35°. The requisite restoring force of the spacer thread sections is formed to be optimal in this range so that the desired shape of the drainage element after the application of force has ended can be reproduced quickly and simply. If the spacer thread sections arranged between the two textile layers are formed to be crescent-shaped in the course thereof then the spacer thread sections advantageously also have the same angle of inclination with respect to the first textile layer as with respect to the second textile layer, thus advantageously an angle of inclination in the range of 1° to 35°. Angles of inclination with respect to the two textile layers of 5°, 6°, 7°, 8°, 9°, 10°, 11°, 12°, 13°, 14°, 15°, 16°, 17°, 18°, 19°, 20°, 21°, 22°, 23°, 24°, 25°, 26°, 27°, 28°, 29°, 30°, 31°, 32°, 33°, 34°, 35° have proved particularly advantageous.

Obviously, this is not to be regarded as limiting, so that it is also possible in the case of crescent-shaped spacer thread sections for the two angles of inclination between first layer and second layer to be different from one another. However, with advantage even in this case the two angles of inclination are selected from the above-mentioned list. With particular advantage, the crescent shape of the spacer thread sections corresponds with the desired shape.

If the course of the spacer thread sections is formed to be oblique, then here the range is from 35° to 110° for the angle of inclination, more advantageously from 70° to 110°, and particularly advantageously of 70°, 72°, 74°, 75°, 76°, 78°, 80°, 81°, 82°, 83°, 84°, 85°, 86°, 87°, 88°, 89°, 90°, 91°, 92°, 93°, 94°, 95°, 96°, 97°, 98°, 99°, 100°, 101°, 102°, 103°, 104°, 105°, 106°, 107°, 108°, 109°, 110°.

In the case of an oblique course of spacer thread sections between the two layers it is conceivable for the spacer thread sections to be arranged always parallel to one another, to run crossing one another in pairs each time or to run crossing one another in quartets each time. By crossing in quartets there is to be understood, advantageously, a total of eight spacer thread sections, wherein in each instance four spacer thread sections, are arranged parallel to one another and the further four spacer thread sections which are similarly arranged parallel to one another, cross the first four spacer thread sections. The respective crossing points are advantageously provided in the lower third of the spacer thread sections, advantageously closer to the second layer than to the first layer. This is beneficial, since as a result in the event of application of force from outside by, for example, a plant container the first textile layer is deflected from its initial position and is displaced flatly in the direction of the second layer. The crossing points near the second layer ensure that there is no contact between the first and second layers. Contact of that kind would prove disadvantageous, since water from watering or rainwater can no longer drain away as desired and undesired waterlogging would form.

In a further advantageous form of embodiment it has additionally proved beneficial for stability of shape of the drainage element to arrange the looping points of the spacer thread sections with first textile layer and second textile layer to be congruent with one another. As a result, particularly in the case of the crescent-shaped form of the spacer thread sections, a sufficiently high restoring force acts, which after application of force enables rapid return to the desired shape of the drainage element. If, however, the spacer thread sections are formed to be oblique, then the looping points of a spacer thread at the first layer and at the second layer are formed to be offset relative to one another. In this case, the monofilament has a zig-zag shape or a sawtooth shape in its path between the first textile layer and the second textile layer.

In a further advantageous form of embodiment it has proved to be of significant advantage to construct the first textile layer to be secure against penetration by root systems. The plant substrate and/or the plant containers is or are, for watering, deposited on the first textile layer. Consequently, this first layer always has direct contact with the plant substrate and/or plant containers. Particularly in the case of the plant substrate such as, for example, soil, the plant roots can penetrate the plant substrate without hindrance and grow. In order to now avoid damage of the drainage element the first textile layer is formed to be impenetrable by root systems. It is thus possible to prevent the plant roots from destroying the drainage element and rendering it unusable.

Even in the case of plant containers, the roots frequently grow out of the lower openings of the plant containers over a longer period of time. By virtue of the construction of the first textile layer to be impenetrable by root systems the plant containers can, even after lengthy periods of time, always be removed easily and directly from this first textile layer without the plant roots having worked into the drainage element and adhering thereto.

For that purpose it has proved advantageous to construct the first textile layer to be of particularly narrow mesh. In that case, a mesh density of 50 to 300 meshes per square centimetre has proved advantageous. With particular advantage, a mesh density of 250 meshes per square centimetre is selected. This particular mesh density on the one hand prevents penetration of the plant roots and on the other hand enables sufficiently rapid drainage of water from watering or of rainwater.

In a further advantageous form of embodiment the second textile layer has interruptions. These interruptions advantageously are constructed as regular openings. These have proved advantageous since through these interruptions in the fabric of the layer a significantly improved and, above all, more rapid capability of water drainage from above to below is made possible. A hexagonal arrangement of the interruptions or openings has provided particularly advantageous. Specifically, this hexagonal arrangement produces sufficiently rapid escape of the water from watering and/or rainwater drained from the first layer. In addition, the connecting webs between the hexagonally arranged interruptions offer a high level of pressure stability and load absorption in the case of application of force.

Moreover, the interruptions themselves are also advantageously constructed in a hexagonal shape. The combination of hexagonal arrangement and hexagonal construction of the interruptions offers a largest possible load-bearing capability and pressure resistance, as well as shear stability over the entire area of the second textile layer. With particular advantage, six hexagonal interruptions arranged hexagonally with respect to one another are provided in an area of 1 square centimetre to 3 square centimetres, wherein the dimensions of the interruptions are in the range of 1 to 4 millimetres in width and 1 to 10 millimetres in length.

Obviously, this is not to be understood as limiting, so that it is also conceivable to provide, particularly in the case of roof greenery, significantly larger dimensions of the interruptions, so that the interruptions in an area range of 25 square centimetres to 50 square centimetres have dimensions in the range of 5 millimetres to 50 millimetres in width and 10 millimetres to 80 millimetres in length.

Obviously it is also conceivable for the interruptions to have the same dimension in their width and in their length. The dimensions already mentioned above are also applicable thereto.

This is obviously not to be understood as limiting, so that it is also possible to construct the interruptions to be polygonal, such as, for example, round, rectangular, oval, lozenge-shaped, square, triangular or in another polygonal form. In particular, the round construction of the interruptions similarly has very good water drainage characteristics.

Consequently, a particularly advantageous form of embodiment of the drainage element for successful, long-term avoidance of waterlogging under plant containers and/or below a plant substrate has the construction, which is impenetrable by root systems, of the first textile layer and the area arrangement of interruptions, advantageously in hexagonal and/or round form, in the second textile layer. The rapid and long-term water drainage is supplemented by the endless monofilament, which in the form of a plurality of spacer thread sections between the two layers enables sufficient air circulation and water drainage.

It is additionally conceivable to construct the second, lower layer as a closed textile layer, thus without interruptions, so that a narrow-mesh lower second layer results. Advantageously, first and second layers can also be constructed to be the same in their characteristics, for example as a narrow-mesh closed textile layer.

In a further advantageous form of embodiment it has also proved advantageous to construct the drainage element to be heatable at least in part and/or for the drainage element to have a pressure stiffness of 10 kilograms per square decimetre to 100 kilograms per square decimetre.

The provision of a heating function is of advantage particularly in nurseries when the water from drainage has to be removed from the plant containers as quickly as possible. For that purpose it has also proved advantageous to provide, apart from the above-described monofilament forming the spacer thread sections and consequently also the cavities between the two textile layers, an additional heating thread which, for example, is similarly constructed as a monofilament.

This heating thread advantageously contains carbon and/or has a core with carbon content, which is coated with a non-conductive plastics material, for example polypropylene, polyethylene or the like. A heating thread of that kind has proved advantageous, since this can be quickly and simply thermally heated, by a power supply unit and/or a battery, advantageously 12 volts, without the risk of electric shock. The plastics material surrounding the carbon has an insulating effect. This is of particular significance for operational reliability and safety relative to water.

Through the heating of the heating thread, which advantageously is similarly fixedly connected with the first textile layer and the second textile layer, for example looped or linked, water between the two layers is heated and evaporated. The removal of water from watering or of rainwater is thus accelerated. Moreover, an area of the soil can thereby be freed from snow and ice and kept free in the long term.

Obviously this is not to be understood as limiting, so that it is also conceivable to also weave and/or knit the heating thread within the first textile layer and/or the second textile layer additionally therewith so that not only the spacing region between the two layers can be subject to temperature influencing, but also the two textile layers themselves can be heated. This serves for more rapid drying.

In a simplest embodiment, the heating thread of continuous construction forms heating thread sections between the two layers. These can have the same geometry as the spacer thread sections already described above or, however, also be formed to be different from the geometry thereof.

Thus, it is conceivable for the spacer thread sections to be of crescent-shaped construction, whereas the heating thread sections between the two layers form a zig-zag shape or sawtooth shape, or conversely. Moreover, it is also conceivable for the spacer thread sections to form a wave shape, whereas the heating thread sections each form a crescent shape. Ratios of spacer thread sections to heating thread sections between first and second textile layers of 95:5 to 55:45 have proved particularly effective for rapid drying. This ensures that the water is removed sufficiently rapidly and at the same time, however, there is no undesired temperature influencing of the plant containers and/or the plant substrate. In principle it has proved that the greater the number of provided heating thread sections between two layers the greater the temperature effect and the warmer the drainage element.

Further, it is of advantage for the drainage element to have a predetermined pressure stiffness so that in the case of external application of force, as already mentioned above, the first textile layer is indeed deflected from its desired shape and displaced in the direction of the second textile layer. However, the pressure stiffness is always dimensioned so that even in the case of application of force, for example by the deposit of a plant container, the two textile layers are formed to always be free of contact with one another and the spacer thread sections always ensure this.

Moreover, the drainage element described herein is for use in nurseries, for example on watering tables, within plant pots as drainage, under turf, for example in football fields where rapid water removal is necessarily pressing after a rain shower, in the cultivation of turf, in football fields for drainage, in roof greenery, where a specific load-bearing capability of the roof should not be exceeded and rainwater similarly has to be rapidly removed, and as a drip catcher in domestic use, for example for wet shoes or wet implements. Moreover, the drainage element described herein can be used as waterlogging protection in construction, for example for lining of moisture-sensitive materials (wood, etc.) in the ground, or also for transport or storage of articles. A further use of the drainage element described herein is as a lying surface, advantageously heatable, for domestic pets or as a sports mat. Moreover, the drainage element described herein can be used in the ground of sports areas, for example below lawn surfaces, in horizontal and/or vertical arrangement.

In addition, use of the drainage element described herein with heating threads, advantageously the plant drainage element with heating threads, as a support for paths and entry areas so as to keep these free of snow and ice in winter, as a safety mat for motorhomes, as an underlay for swimming pools or paddling pools for children, as a support for animals and at outer walls of raised beds for the avoidance of waterlogging is advantageous.

Advantageously, water-repelling synthetic materials constructed as textile threads are used as materials for the drainage element described herein. It is conceivable for the first textile layer and the second textile layer as well as the monofilament to be formed from the same synthetic material. However, it is also conceivable for the first textile layer to consist of a synthetic material different from the second textile layer or to consist of a synthetic material different from the monofilament. Advantageously, the monofilament is selected from a thermoplastic plastics material from the group of polypropylene, polyethylene, polyethylene terephthalate, polyester, polyether sulfone and/or a combination thereof. Moreover, it is conceivable to construct the at least one monofilament from at least one inorganic fibre, for example from glass fibres.

Further, it is also conceivable to provide, apart from the already described spacer thread sections and/or the at least one heating thread containing carbon, a further kind of thread between the first textile layer and the second textile layer, particularly if constant watering is desired while preventing waterlogging. This form of embodiment is usable and suitable particularly for drainage elements within plant containers. In this case, provided between the first textile layer and the second textile layer apart from the spacer thread sections constructed from monofilament and the heating thread sections, as described above, are water-conducting spacer thread sections which ensure a predetermined uniform moisture of the plant roots. Water-conducting spacer threads of that kind can also be constructed from a further monofilament.

In the case of the water-conducting spacer threads, natural materials such as, for example, raffia, have proved particularly advantageous. If the water-conducting spacer thread sections are formed from synthetic material, then the synthetic material is to be constructed to be hygroscopic, for example from polyamide.

Moreover, the drainage element described herein is constructed to be distortion-free, long-lifed, resistant to ultraviolet light, stable in shape in the case of loading by perpendicular force, washable up to 60° C. and resistant to weathering and chemicals.

### BRIEF DESCRIPTION OF THE DRAWINGS

Advantages and functionalities can be inferred from the following description in conjunction with the drawing, in which:

FIG. 1 shows a schematic cross-section of a first form of embodiment of the drainage element;

FIG. 2 shows a further schematic cross-section of a further form of embodiment of the drainage element;

FIG. 3 shows a further schematic cross-section of a further form of embodiment of the drainage element;

FIG. 4 shows a schematic plan view of a form of embodiment of the second textile layer; and

FIG. 5 shows a schematic plan view of a further form of embodiment of the second textile layer.

### DETAILED DESCRIPTION OF THE INVENTION

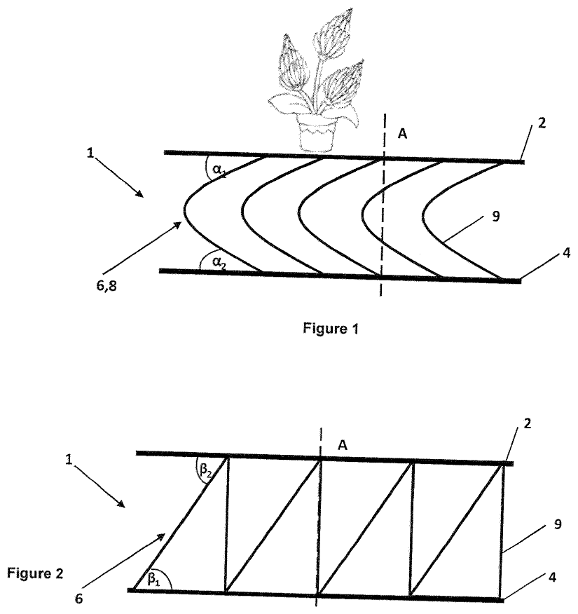

A schematic cross section of a drainage element 1 is shown in FIG. 1. The first textile layer 2 forms the upper side of the drainage element 1. A plant container or plant substrate, for example, can be placed on this upper side.

The second textile layer 4 is constructed to lie opposite thereto. The two layers 2, 4 are arranged to be spaced from one another by way of a spacer element 6. In this illustrated embodiment the spacer element 6 is provided as a monofilament which, as an endless thread, is fixedly connected with the two layers 2, 4. The spacer element 6 constructed as a monofilament has a plurality of spacer thread sections 9 which describe a curved, advantageously crescent-shaped, course. The spacer thread sections 9 are advantageously arranged at the same mutual spacing and with the same course of curvature with respect to one another.

As the dashed line A shows, the spacer thread sections 9 are knitted with the first textile layer 2 and the second textile layer 4 by way of loopings. The loopings are in that case formed one above the other and consequently congruent with respect to one another. It has proved particularly advantageous if the angles of inclination α₁ and α₂ are the same. In that regard, an angle of inclination range of 5 to 35° has proved particularly advantageous for the requisite load stability and the restoring force necessary in the case of application of force.

If an article such as, for example, a plant container or an implement, is deposited on the upper, first textile layer 2 then the spacer thread sections 8 are loaded and deformed by a force acting vertically downwardly. The upper, first textile layer 2 is at least partly displaced in the direction of the lower, second textile layer 4. Deflection from the original, desired shape shown in FIG. 1 takes place under compression of the spacer thread sections so that the curvature thereof is additionally amplified.

If the article is now removed, then due to the angle of inclination as well as the curved path of the spacer thread sections 9 between the two layers 2, 4 a sufficient restoring force is provided in order to guide the first textile layer back away from the second textile layer and return it to the desired shape.

A further form of embodiment of the drainage element 1 is shown in FIG. 2. Here, too, the upper, first textile layer 2 is arranged at a spacing from the lower, second textile layer 4 by at least one spacer element 6. The spacer element 6 is advantageously constructed as an endless monofilament here as well, this having a plurality of spacer thread sections 9 between the two layers 2, 4. In FIG. 2 the spacer thread sections 8 are now provided at an inclination and vertically, in which case it is also apparent here from the dashed line A that the looping points of the spacer thread sections 9 at the upper, first textile layer 2 and at the lower, second textile layer 4 are arranged congruently with and oppositely to one another.

In addition, the spacer thread sections 9 form a sawtooth profile. This arrangement has also proved advantageous for a sufficient restoring force and a sufficient load stability. Advantageously, the angles of inclination β₁ and β₂ are formed to be the same and lie in the range of 50 to 80°.

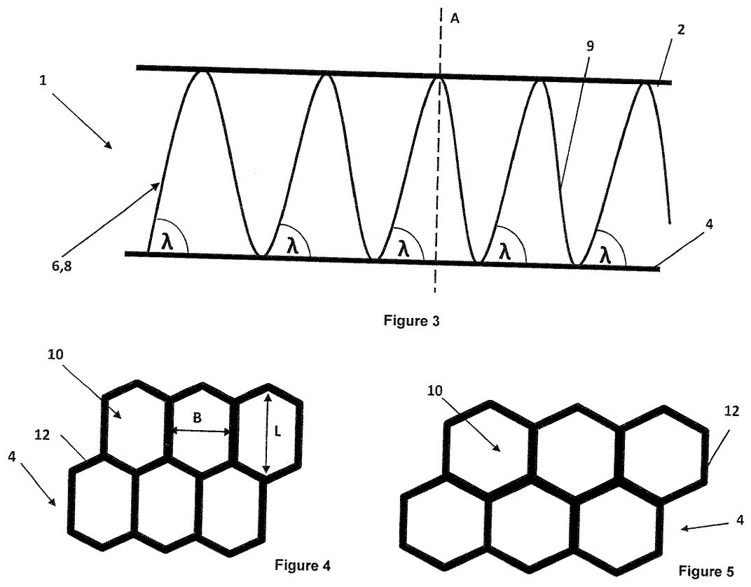

A further form of embodiment of a schematic cross-section of a drainage element 1 is shown in FIG. 3, wherein here the upper, first textile layer 2 and the lower, second textile layer 4 are arranged at a spacing from one another by spacer thread sections 8. In this embodiment the spacer thread sections 9 have a parabolic, repeating cross-section. It is apparent from the dashed line A that in this form of embodiment of the drainage element 1 the looping points of the two layers 2, 4 are arranged to be offset relative to one another. Advantageously, the angle of inclination λ of the parabolic spacer thread sections 9 is formed in the range of 70 to 110°.

A schematic plan view of the lower, second textile layer 4 is shown in FIGS. 4 and 5, wherein here, in particular, reference is made to the interruptions 10. The interruptions 10 are formed as openings permeable by water and are stabilised by the webs 12. The webs 12 additionally also serve for fixing the spacer thread sections 9 (not shown). The interruptions 10 can be formed be variable in their geometry depending on the desired load stability and rate of water removal. Thus, by way of example FIG. 4 shows a hexagonal grid of interruptions 10 and webs 12, wherein the interruptions 10 are formed to be smaller in the width B thereof than in the length L thereof.

On the other hand, a symmetrical hexagonal grid of interruptions 10 and webs 12 is shown in FIG. 5, where the interruptions 10 are of the same dimension in the width B thereof and in the length L thereof. This is obviously not to be understood as limiting, so that it is also conceivable for the interruptions 10 to be constructed to be larger in the width B thereof than in the length L thereof. Moreover, rectangular, square, circular of other polygonal interruptions 10 can also be provided. In the case of a circular shape, a diameter of 0.5 centimetres to 10 centimetres has proved to be advantageous, more advantageously 1.5 centimetres or 6 centimetres.

All features disclosed in the application documents are claimed to be of significance to the invention insofar as they are new individually or in combination relative to the prior art.

### Reference Numeral List

1 drainage element
2 upper, first textile layer
4 lower, second textile layer
6 spacer element
8 spacer thread
9 spacer thread sections
10 interruptions
12 webs

1: A textile drainage element of laminar form for avoidance of waterlogging of plants, comprising at least one first textile layer configured for accepting at least one plant container or plant substrate and at least one second textile layer, which is arranged to be laminarly opposite the first textile layer, wherein the first textile and the second textile layer are formed of water-repelling synthetic materials for improved drainage of a liquid, wherein at least one spacer element formed of a monofilament or polyfilament textile material is arranged between first textile layer and second textile layer and fixedly connects the first textile layer and the second textile layer together, wherein the spacer element is constructed as at least one spacer thread formed of a thermal plastic material selected from the group consisting of polypropylene, polyethylene, polyethylene terephthalate, polyester, polyethersulfone and a combination thereof, or glass fibers, and wherein the at least one spacer thread is formed to be looped with the first textile layer and with the second textile layer.

2: The drainage element according to claim 1, wherein the at least one spacer thread has an oblique or a curved form in its path between the first textile layer and the second textile layer.

3: The drainage element according to claim 2, wherein the spacer thread sections form together with the second textile layer an angle of inclination of 5° to 130°.

4: The drainage element according to claim 1, wherein the looping points of spacer thread with the first textile layer and spacer thread with the second textile layer are arranged to be congruent with one another.

5: The drainage element according to claim 1, wherein the first textile layer is formed to be impenetrable by root systems.

6: The drainage element according to claim 1, wherein the second textile layer has interruptions.

7: The drainage element according to claim 1, wherein the drainage element is constructed to have a pressure resistance of 1 to 100 kilograms per square decimetre.

8: A method for avoidance of waterlogging of plants in nurseries, in plant pots, under turf and in roof greenery and for catching drips in domestic use for wet shoes and wet implements, which comprises deploying a textile drainage element as claimed in claim 1 as a floor or ground covering.

9: The method according to claim 8, wherein the at least one spacer thread has an oblique or a curved form in its path between the first textile layer and the second textile layer.

10: The method according to claim 9, wherein the spacer thread sections form together with the second textile layer an angle of inclination of 5° to 130°.

11: The method according to claim 8, wherein the looping points of spacer thread with the first textile layer and spacer thread with the second textile layer are arranged to be congruent with one another.

12: The method according to claim 8, wherein the first textile layer is formed to be impenetrable by root systems.

13: The method according to claim 8, wherein the second textile layer has interruptions.

14: The method according to claim 8, wherein the drainage element is constructed to have a pressure resistance of 1 to 100 kilograms per square decimetre.

15: The drainage element of claim 1, further including a heating thread arranged between the first textile layer and the second textile layer.

16: The drainage element of claim 15, wherein the heating thread comprises a carbon core coated with a non-conductive plastics material.

17: The method according to claim 8, wherein the drainage element further includes a heating thread arranged between the first textile layer and the second textile layer.

18: The method according to claim 17, wherein the heating thread comprises a carbon core coated with a non-conducting plastic material.
